(19) United States
(12) Patent Application Publication
(10) Pub. No.: US 2006/0129781 A1
(43) Pub. Date: Jun. 15, 2006

(54) Offline configuration simulator

(76) Inventors: Andrew P. Gellai, Tucson, AZ (US); Joseph A. Gimness, Tucson, AZ (US); John R. Paveza, Morgan Hill, CA (US); Jens Wissenbach, Mainz (DE)

Correspondence Address: QUARLES & BRADY STREICH LANG LLP, 1 SOUTH CHURCH AVENUE, SUITE 1700, TUCSON, AZ, 85701, US

(21) Appl. No.: 11/012,632

(22) Filed: Dec. 15, 2004

(51) Int. Cl. G06F 12/00

(52) U.S. Cl. 711/170; 711/114

(57) ABSTRACT

An offline configuration simulator allows a user to model and manage a simulated data storage system. Once the simulated data storage system is properly configured, a configuration file is applied to a corresponding real data storage system. An existing configuration of the data storage system can be imported into the offline configuration system for further modification.

### BACKGROUND OF THE INVENTION

1. Field of the Invention

This invention is related in general to data storage systems. In particular, the invention consists of an offline configuration simulator to model and manage a simulated data storage system.

2. Description of the Prior Art

A data storage system may be a complex collection of information servers, processing devices, redundant arrays of independent/inexpensive disks (“RAIDs”), magneto-optical drives, tape cartridges, and automated devices for loading memory storage devices into data readers, forming a library of digital information. A primary information server is referred to as a host and all other components are considered attachments.

Adding attachments to the host can be a complicated and time-consuming process. For example, adding a new RAID may require that each hard-disk drive be formatted, the collection of hard-disk drives striped, and the resulting cumulative memory space being split into one or more logical volumes. In this manner, each hard-disk drive has an associated physical address while each volume has an associated logical address. The host must be configured with both the physical and logical addresses of its attachments.

A traditional data-storage configuration system 10 is illustrated in FIG. 1, including clients 12, a storage management interface 14, and a device under test (“DUT”) 16. Clients are digital communication devices such as computer terminals, personal computers, and personal digital assistants (“PDAs”) that allow a user to communicate with the DUT. The DUT 16 includes a data storage system 18 including a host server 20 and associated attachments 22.

The storage management interface 14 includes a management application programming interface (“API”) 24, a configuration data model 26, and functional code 28. The configuration data model 26 is a digital representation of the physical layout of the DUT 16. The management API 24 is a collection of software method calls that responds to configuration commands 30 issued by the clients 12 to retrieve information from the configuration data model 26 and perform configuration activities on the DUT 16 utilizing the functional code 28.

An exemplary configuration activity begins with the physical attachment of a hard-disk drive 22A by a service technician. The service technician may then issue a configuration command 30 through the client 12 invoking a format method within the management API 24. The format method retrieves the physical address of the hard-disk drive from the configuration data model and utilizes the functional code 28 to erase and prepare the hard-disk drive 22A. Once the hard-disk drive 22A has been formatted, it may be partitioned, added to a RAID 22B, and divided into logical volumes. Because logical devices such as volumes have addresses different from the physical addresses maintained in the configuration data model 26, the virtual layout of a data storage system 18 is referred to as it logical configuration 32. This logical configuration may be maintained in the storage management interface 14.

Configuration of a data storage system 18 may be a complicated and time-consuming process. For example, adding RAIDS to the data storage system 18 will require that each hard-disk drive be formatted, partitioned, and striped. If the data storage system 18 is configured improperly, an error message 34 may be generated by the DUT 16 requiring the user to start the configuration process over. It would be desirable to have a method for configuring a data storage system that can address configuration errors without having to redo time-intensive tasks such as disk formatting.

In order to reduce the amount of time spent re-doing system configuration activities, a user must spend considerable time planning the data-storage system configuration. Additionally, experimentation with system configurations is usually prohibited by the associated time and expense. It would be desirable to have a method of configuring a data storage system that does not require extensive planning and allows for experimentation to determine an optimal configuration.

Another drawback associated with traditional data-storage system configuration is that physical hardware (host/attachments) must be present before configuration may begin. This means that a time-intensive system configuration cannot begin until all the components are present. Accordingly, it would be desirable to have a method for configuring a data storage system before all the components are present, allowing for quicker installation of the system once the parts arrive.

One approach to meeting these needs involves configuring a simulated data-storage system, as illustrated in FIG. 2. An initial setup assistant (“ISA”) 40 includes a graphical user interface (“GUI”) 42 and a business configuration component 44, and a simulated configuration data model 46. The business configuration component 44 performs simulated configurations that a user may use to develop an optimal configuration. The resulting simulated configuration 48 is placed in a digital file 50 which is transported to the DUT 18. An onboard configuration loading tool 52 applies the simulated configuration 48 to the data storage system 18.

One problem with the ISA 40 is that the business configuration component 44 is usually not accessible by other management applications. This forces third-party storage management applications to continue to utilize the traditional data-storage configuration system 10. Another issue with the ISA 40 is that the simulated configuration data model 46 is not identical to the configuration data model 26 of the traditional data-storage configuration system 10, requiring extensive translation between the two data models. This makes it difficult to import a physical configuration from the DUT 16. Additionally, the ISA 40 has no mechanism for importing the logical configuration 32. This requires that all simulated configurations begin with a clean configuration, i.e., having no established logical devices. Data storage systems that have been previously configured must have their logical configurations erased.

One aspect of the ISA 40 requires that simulated configurations be saved to digital files. The traditional format of the digital files, XML, precludes multiple users from simultaneously configuring the same data storage system. Accordingly, it would be desirable to have a system for simulating a configuration of a data storage system that allows access by multiple users and third-part storage management applications. Additionally, it would be desirable for this simulated configuration system to utilize a common configuration data model and allow importation and editing of an existing logical configuration.

### SUMMARY OF THE INVENTION

The invention disclosed herein utilizes an offline configuration system to model and manage a simulated data storage system. Multiple clients may simultaneously configure the data storage system via a storage management interface. The storage management interface includes a management API with extensions for handling offline configuration commands. A user may implement either a traditional online configuration or may invoke an offline configuration processor to simulate a configuration. Both online and offline configurations utilize a common configuration data model to eliminate the need for translations between the two.

Offline configurations may be placed in an office configuration repository for later use or comparison with other simulated configurations. Once the simulated data storage system is properly configured, the simulated configuration is applied to the real data storage system in much the same manner as an online configuration. However, the simulated configuration may be applied in an automated manner, as well. In this manner, third-part storage management applications written for online configurations may be applied to offline configurations as well. Additionally, an existing logical configuration of the data storage system can be imported into the offline configuration system for further modification. This allows an existing configuration to be modified without having to start anew.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is a block diagram illustrating a traditional data-storage configuration system including a traditional storage management interface.

FIG. 2 is a block diagram illustrating an initial setup assistant (“ISA”) used for offline configurations.

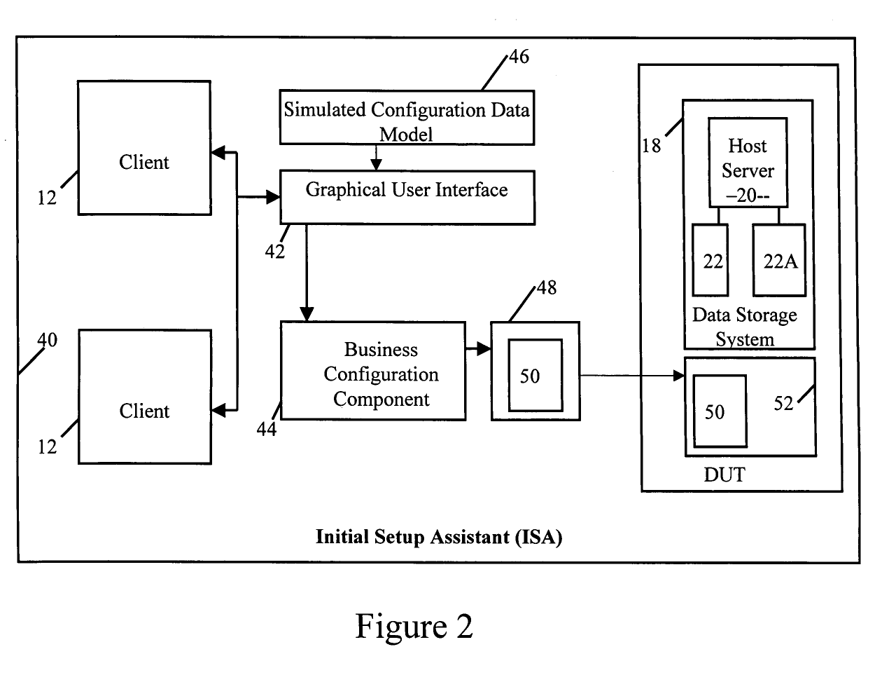

FIG. 3 is a block diagram of an offline configuration system (“OCS”) including management API extensions, an offline configuration processor, and an offline configuration repository.

FIG. 4 is a flow chart illustrating the process of performing an offline configuration of a data storage system.

### DESCRIPTION OF THE PREFERRED EMBODIMENTS

This invention is based on the idea of simulating a configuration of a data storage system. The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (“FPGAs”), application-specific integrated circuits (“ASICs”), complex programmable logic devices (“CPLDs”), programmable logic arrays (“PLAs”), microprocessors, or other similar processing devices.

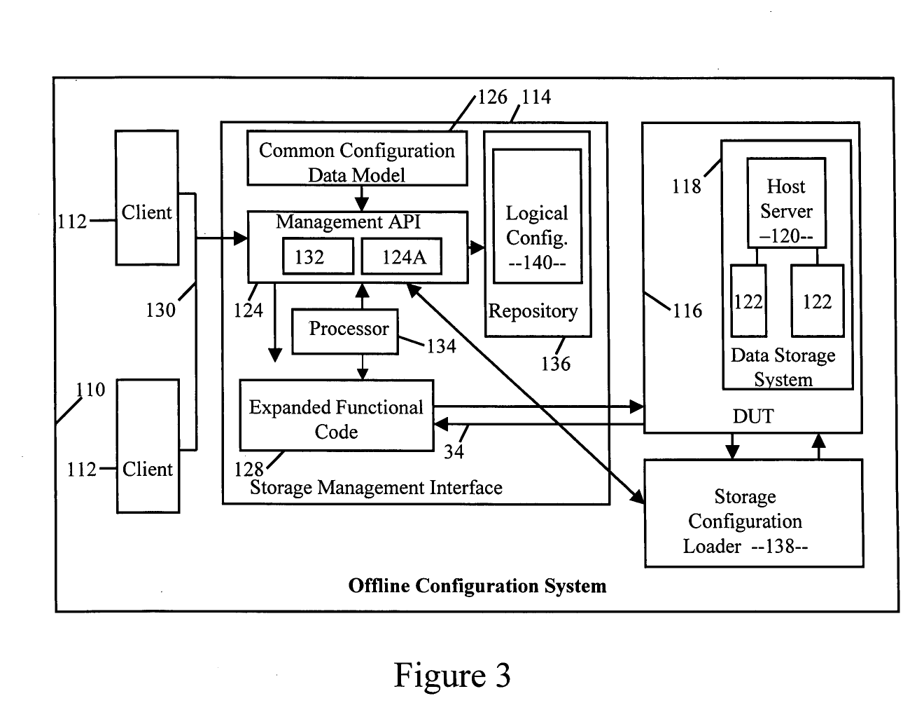

Referring to figures, wherein like parts are designated with the same reference numerals and symbols, FIG. 3 is a block diagram of an offline configuration system (“OCS”) 110 including clients 112, a storage management interface 114, and a device under test (“DUT”) 116. The DUT 116 includes a data storage system 118 including a host server 120 and associated attachments 122.

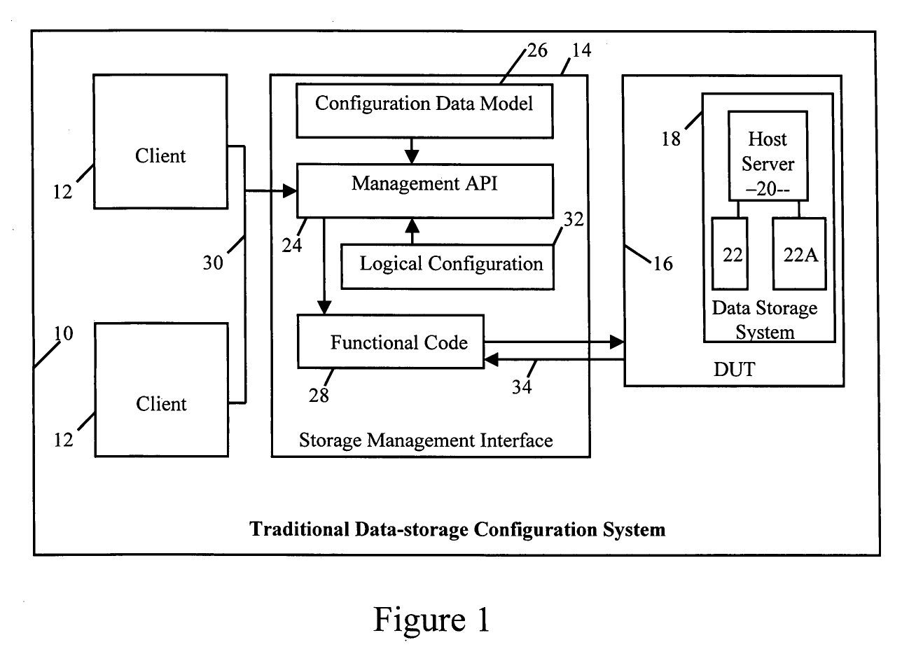

The storage management interface 114 includes a management application programming interface (“API”) 124, a common configuration data model 126, and expanded functional code 128. The common configuration data model 126 and expanded functional code 128 are utilized for both online and offline configurations. The management API 124 includes method call extensions 124A for handling offline configuration commands. Offline configuration commands 130 set a flag 132 in the management API 124. This flag 132 is used by the management API 124 to determine whether traditional method calls are use, or whether method call extension 124A are used. By using an expanded version of the traditional management API 24 (FIG. 1), expanded functional code 128, and a common configuration data model 26, the offline configuration system 110 provides full access for third-party storage management applications. Additionally, the common configuration data model 26 eliminates the need for translations of offline configurations into online configurations.

Offline configuration simulations are executed in the offline configuration processor 134. The offline configuration processor is a computing device such as a field-programmable gate array (“FPGA”), an application-specific integrated circuit (“ASIC”), or a programmable logic device (“PLD”). Information regarding the physical structure of the data storage system 118 is retrieved from the common configuration data model via the management API 124. An interesting aspect of this invention is that the common configuration data model can be adjusted to indicated anticipated physical hardware, allowing system configuration before all the hardware is physically connected.

One of the purposes of configuration simulation is to detect and correct error conditions in a timely manner. Additionally, configuration simulation allows a user to test several disparate system configurations before setline on an optimal solution. Each instance of an offline configuration may be saved to the offline configuration repository 136, including a data storage device such as a floppy-disk, a hard-disk, a tape cartridge, or a magneto-optical disk. In this embodiment of the invention, the offline configurations are saved in an object-relational data structure 139. This allows multiple users to implement the offline configuration system 110 for the same data storage system 118. Once an offline configuration has been decided on, it can be applied to the data storage system in the same manner as an online configuration.

Another aspect of the invention is a storage configuration loader 138 for capturing the logical configuration 140 of the data storage system 118. This feature allows a simulated configuration to begin from data storage system's existing logical state, rather than requiring a clean system.

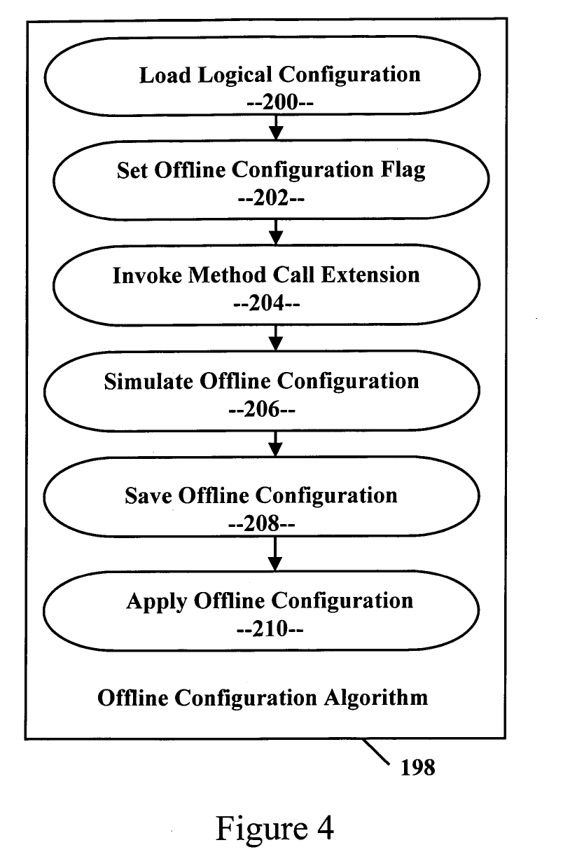

FIG. 4 is a flow chart illustrating the process of performing an offline configuration of a data storage system as indicated in the offline configuration algorithm 198. An optional step 200 involves the loading of the logical configuration 140 from the data storage system 118 to the storage management interface 114. In step 202, a user issues an offline configuration command 130 that sets an offline configuration flag 132 in the management API 124. In step 204, additional offline configuration commands 132 invoke method call extensions 124A which retrieve physical information about the data storage system 118 from the common configuration data model 126. An offline configuration is simulated in the offline configuration processor 134 in step 206. Each instance of offline configuration is optionally saved to the offline configuration repository in step 208. An offline configuration is applied to the data storage system 118 in step 210.

Those skilled in the art of making memory management systems may develop other embodiments of the present invention. However, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. An offline configuration simulator, comprising:
a device under test including a data storage system;
a first client for allowing a first user to transmit offline configuration commands; and
a storage management interface including a management application programming interface, a common configuration data model, expanded functional code, and an offline configuration processor; wherein the storage management interface connects the first client to the device under test and allows the user to simulate a first offline configuration of the data storage system.

2. The offline configuration simulator of claim 1, wherein the data storage system includes a host server and a plurality of attachments.

3. The offline configuration simulator of claim 1, wherein the offline configuration processor saves the first offline configuration to an offline configuration repository.

4. The offline configuration simulator of claim 1, wherein the storage management interface connects a second client to the device under test and allows a second user to simulate a second offline configuration of the data storage system.

5. The offline configuration simulator of claim 1, wherein the offline configuration processor saves the first offline configuration to an offline configuration repository, the storage management interface connects a second client to the device under test, and the storage management interface allows a second user to simulate a second offline configuration of the data storage system.

6. The offline configuration simulator of claim 5, wherein the offline configuration processor saves the second offline configuration to the offline configuration repository.

7. The offline configuration simulator of claim 3, wherein the offline configuration repository includes an object-related data structure.

8. The offline configuration simulator of claim 1, wherein the storage management interface includes an offline configuration flag for indicating that said first user is simulating the first offline configuration.

9. The offline configuration simulator of claim 8, furthering comprising a storage configuration loader for capturing a logical configuration of the data storage system and placing the logical configuration in the storage management interface.

10. A method of configuring a data storage system, comprising the steps of:
retrieving physical layout information representative of the data storage system from a common configuration data model;
simulating an offline configuration of the data storage system in an offline configuration processor; and
applying the offline configuration to the data storage system.

11. The method of claim 10, further comprising the step of loading a logical configuration of the data storage system prior to the step of simulating an offline configuration.

12. The method of claim 10, further comprising the step of setting an offline configuration flag prior to the step of simulating an offline configuration.

13. The method of claim 10, further comprising the step of saving the offline configuration to an offline configuration repository.

14. The method of claim 13, wherein the offline configuration repository is an object-related data structure.

15. An article of manufacture including a data storage medium, said data storage medium including a set of machine-readable instructions that are executable by a processing device to implement an algorithm, said algorithm comprising the steps of:
retrieving physical layout information representative of the data storage system from a common configuration data model;
simulating an offline configuration of the data storage system in an offline configuration processor; and
applying the offline configuration to the data storage system.

16. The article of manufacture of claim 15, further comprising the step of loading a logical configuration of the data storage system prior to the step of simulating an offline configuration.

17. The article of manufacture of claim 15, further comprising the step of setting an offline configuration flag prior to the step of simulating an offline configuration.

18. The article of manufacture of claim 15, further comprising the step of saving the offline configuration to an offline configuration repository.

19. The article of manufacture of claim 18, wherein the offline configuration repository is an object-related data structure.
